(19) United States
(12) Patent Application Publication
(10) Pub. No.: US 2018/0005524 A1
(43) Pub. Date: Jan. 4, 2018

(54) Systems and Methods for Alerting an Operator to an Emergency Vehicle and/or Automated Control of Vehicle

(71) Applicant: KCG Technologies LLC, Boston, MA (US)

(72) Inventor: Michael Kildevaeld, Yarmouth Port, MA (US)

(21) Appl. No.: 15/635,424

(22) Filed: Jun. 28, 2017

Related U.S. Application Data
(60) Provisional application No. 62/355,792, filed on Jun. 28, 2016.
(60) Provisional application No. 62/381,528, filed on Aug. 30, 2016.
(60) Provisional application No. 62/376,371, filed on Aug. 17, 2016.
(60) Provisional application No. 62/515,612, filed on Jun. 6, 2017.

(51) Int. Cl. G08G 1/0965; G08G 1/16; G08G 1/0968

(52) U.S. Cl. CPC G08G 1/0965; G08G 1/096844; G08G 1/162

(57) ABSTRACT

This disclosure relates to improving the safety of motor vehicles operating when an emergency vehicle is responding to an emergency. Disclosed are methods and systems for allowing motor vehicle operators to avoid accidents through alerts provided to the motor vehicle operators. The disclosed methods and systems allow motor vehicles to receive information from emergency vehicles and respond to the information in an appropriate way.

### FIELD

This disclosure relates generally to the field of automobile safety and automated vehicle control.

### BACKGROUND

Emergency responders serve many important functions in society. They respond to fires, motor vehicle accidents, and transport victims of medical emergencies to hospitals on a daily basis. Without emergency responders, society as a whole would suffer billions of dollars in loses per year, as well as needless loss of life and property. These individuals are necessary to a functioning society

Emergency responders are often required to respond rapidly to an emergency situation. This requires vehicles moving on common use roadways with civilian operators on the roads. Emergency responders must often move through congested traffic near urban areas, at much higher speeds than other vehicles, and run through traffic lights. Emergency responders also rely on other motor vehicles to move out of the way of the emergency vehicle and allow their vehicles to perform their duties safely.

Unfortunately, distractions lead many motor vehicle operators to ignore emergency vehicles. This leads to danger for both emergency vehicle operators and other civilian operators. Data indicates that vehicle fatality rates for accidents involving emergency vehicles can be up to five times higher than the national average. According to the National Highway Safety Administration, ambulance, fire truck, and police car accidents account for nearly 350 fatalities every year. This is due to many factors, including drivers distracted by phone use, drivers not realizing an emergency vehicle is coming to an intersection or from behind, and emergency vehicles traveling through poorly lit areas. These accidents also lead to loss of property and other societal costs due to the emergency vehicles not attending to the original emergency in the first place. For these reasons, there remains a need to allow for vehicles to alert drivers to the oncoming emergency vehicle and, in some cases, to provide an automated method of preventing a potential accident.

### SUMMARY

Disclosed herein are systems and methods that improve the safety of emergency vehicles and civilian operators on the road. The systems and methods allow for emergency vehicles to communicate with civilian vehicles to alert the civilian vehicle of an approaching emergency vehicle. The disclosed methods and systems allow for an active emergency vehicle to transmit information to a civilian vehicle or other inactive emergency vehicle traveling within a certain radius of the system relating to the vehicles position, direction of travel, and speed. The disclosed methods and systems further allow for an active emergency vehicle to instruct other vehicles on the road to reduce the volume of radios or other features (such as phone).

The disclosed methods and systems further allow for an active emergency vehicle to instruct the onboard systems of other vehicles to displace maps or other features on a screen in a vehicle receiving the instructions. The visualization would display one or more of: (1) location of the emergency vehicle relative to the vehicle receiving the signal from the emergency vehicle; (2) velocity of the emergency vehicle relative to the vehicle receiving the signal, (3) verbal alert that an emergency vehicle was approaching and the direction of approach; (4) an alarm warning of an approaching emergency vehicle; (5) video of the approaching emergency vehicle taken from one or more cameras positioned on the receiving vehicle; and (6) an animation of the emergency vehicle on a screen located within the vehicle.

Aspects of the disclosed methods and systems allow for an emergency vehicle to send instructions to vehicles receiving the signal to take control of the vehicle. In such aspects, the receiving vehicle would take control of operations of the vehicle so as to pull over, slow down, or stop. Such an automated response would further reduce the potential for operator error and allow the vehicle receiving the instructions to avoid impeding the path of the emergency vehicle.

Aspects of the methods include a method of alerting an operator of a motor vehicle to the presence of an emergency vehicle in the operator's vicinity. The method comprises receiving information from the emergency vehicle by wireless communication to the motor vehicle and in response to the received information, overriding one or more systems in the motor vehicle, the one or more systems comprising radio volume control, phone volume control, screen functionality, onboard camera functionality, or combinations thereof. In particular embodiments, the method comprises alerting the operator of the motor vehicle to the presence of the emergency vehicle.

Aspects of the methods also include a method of controlling a motor vehicle in response to information received from an emergency vehicle. The method comprises receiving information from the emergency vehicle by wireless communication to the motor vehicle and in response to the received information, overriding operation of the motor vehicle to perform an operation of reducing speed of the motor vehicle, pulling to one side of the road of the motor vehicle, and/or stopping the motor vehicle. In some embodiments, once the emergency vehicle information is no longer received by the motor vehicle, allowing the motor vehicle to return to a normal operational state.

Aspects of the systems disclosed herein include a system for alerting an operator of a motor vehicle to the presence of an emergency vehicle in the operator's vicinity comprising a processor operably linked to a memory storing executable instructions. The processor executes the instructions to receive information from the emergency vehicle by wireless communication to the motor vehicle. The processor further executes the instructions to override one or more systems in the motor vehicle, the one or more systems comprising radio volume control, phone volume control, screen functionality, onboard camera functionality, or combinations thereof; and

In some embodiments, the processor executes the instructions to generate an alert such that the operator of the motor vehicle is aware of the presence of the emergency vehicle. In certain embodiments, the motor vehicle takes control from the operator of the motor vehicle to execute a maneuver such as moving the car over to the side of the road, slowing the car down, or bringing the car to a stop.

Aspects of the disclosed systems include a system for controlling a motor vehicle in response to information received from an emergency vehicle comprising a processor operably linked to a memory storing executable instructions. The processor executes the instructions to receive information from the emergency vehicle by wireless communication to the motor vehicle.

In some embodiments, the processor executes instructions to override operation of the motor vehicle to perform an operation of reducing speed of the motor vehicle, pulling to one side of the road of the motor vehicle, and/or stopping the motor vehicle.

In other embodiments, the processor executes instructions to return to a normal operational state when the motor vehicle either receives no information from the emergency vehicle or the emergency vehicle instructs that normal operation of the motor vehicle should resume.

It should be noted that the aspects disclosed herein further allow for communications from a motor vehicle to an emergency vehicle. In particular embodiments, the motor vehicle sends a communication to the emergency vehicle sending an alert signal that indicates the motor vehicle received the signal. In further embodiments, the motor vehicle determines whether the signal is authentic based on information stored in the memory.

### BRIEF DESCRIPTION OF THE FIGURES

To further understand the systems and methods disclosed herein, reference is directed to the following brief description of the figures as well as the drawings that show exemplary embodiments of the systems and methods:

FIG. 1A is a representation showing the hardware of an exemplary system, while FIG. 1B is a representation of the arrangement of four transceivers on the motor vehicle;

FIG. 2 is a flowchart showing the action taken during operation of an exemplary system;

FIG. 3 is a pictorial representation showing the interaction between an emergency vehicle and a motor vehicle;

FIG. 4 is a flowchart showing the action taken during operation of an exemplary system in an automated vehicle;

FIG. 5 is a flowchart showing the interaction of the motor vehicle with the interne.

### DETAILED DESCRIPTION

1. Systems

Disclosed herein are systems that allow for increased safety on roadways by decreasing the potential for accidents between civilian motor vehicles (hereinafter, “motor vehicles”) and emergency vehicles. As used herein, the term “emergency vehicle” means any vehicle that is used to transport personnel, equipment, or other materials necessary to respond to an emergency. Examples of emergency vehicles are police cars, fire trucks, ambulances, armored vehicles, and any other vehicle used by emergency personnel.

The systems disclosed herein allow for one- or two-way communication between an emergency vehicle and a motor vehicle. The emergency vehicle can communicate with a motor vehicle over a wireless network. Examples of wireless networks include wireless PAN, wireless LAN, wireless MAN, wireless WAN, and global area networks. In addition, the motor vehicle and emergency vehicle can access information on one or more remote servers relating to weather conditions, road conditions, or any other information pertinent to the situation.

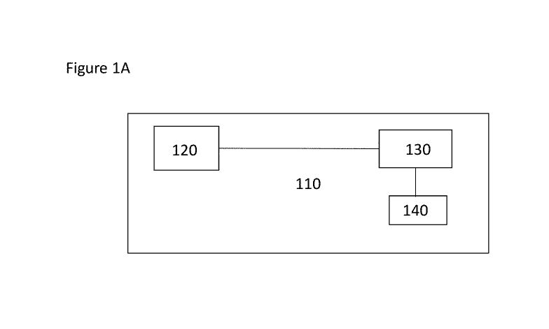

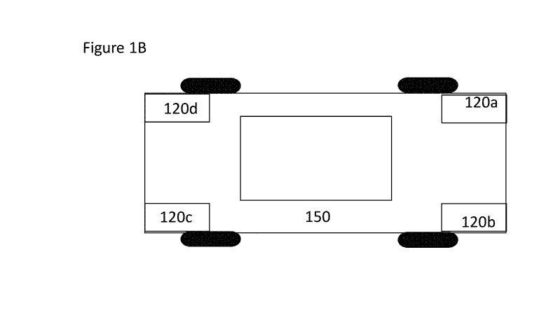

An exemplary system disclosed herein comprise is shown in FIG. 1A. The system 100 comprises one or more wireless transceivers 120 provided on motor vehicle 110. The transceivers 120 are configured to receive and transmit messages using a wireless protocol. In this embodiment, the transceivers 120 use the Zigbee IEEE 802.15.4-based specification for short-range PAN communications and wireless protocols using the IEEE 802.11 WLAN and WMAN the IEEE 802.16 standards. The motor vehicle 110 can receive messages at short distances and over larger distances in very congested urban areas. FIG. 1B shows the arrangement of four transceivers 120a, 120b, 120c, and 120b on the motor vehicle 150.

The motor vehicle 110 further comprises a processor 130 that is operably linked to a memory 140. Exemplary memory includes RAM, cache memory, hard disk memory, or any computer-readable memory capable of storing information. The memory 140 stores instructions that are responsive to a receipt of information from an emergency vehicle. The instructions stored in the memory can include accessing information relating to vehicle information such as speed, tire pressure, coolant temperature, oil, and fuel, road condition information such as construction conditions, map, navigation, road width, and speed limits, as well as weather conditions or information relating to the emergency vehicle or motor vehicle. In addition, the instructions allow accessing the internet to obtain information.

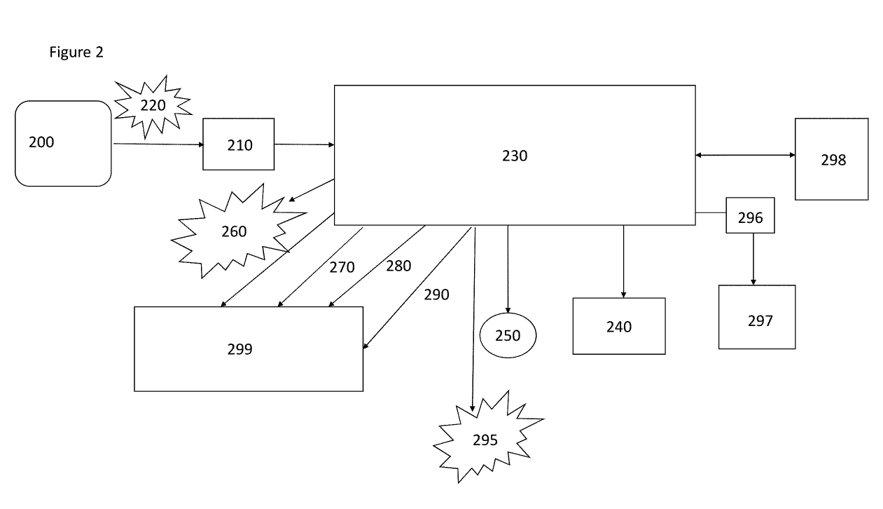

As shown FIG. 2, when the transceiver 210 receives an alert message 220 from an emergency vehicle 200, the alert message 220 comprises a variety of information, including information relating to the source of the message, the destination of the message, the type of vehicle sending the message, the location of the vehicle, the direction of the vehicle, and the speed of the vehicle.

As shown in FIG. 2, upon receipt of the message 220, the processor 230 executes instructions stored in memory 298 to override one or more systems in the vehicle. The systems include radio volume control, phone volume control, screen functionality, onboard camera functionality to show the emergency vehicle approaching in real-time and in real video imagery, vehicle operation, or combinations thereof. The override command 240 takes priority over any operator 299 controls in the vehicle and allows the vehicle to operate one or more of the vehicle's functionalities. Once the override command 240 is executed by the processor 230, the operator 299 cannot control the one or more systems until the processor 230 issues a revocation command 250, revocating the override command 240. The revocation command 250 is executed only when the alert message 220 is no longer received from the emergency vehicle 200. Lack of receipt of the alert message 220 can occur when the emergency vehicle 200 moves out of range of the vehicle or when the emergency vehicle 200 discontinues the alert message 220.

The processor 230 also generates an alert instruction 260 to the operator 299 of the motor vehicle. The alert instruction 260 can instruct the vehicle's sound system to generate a sound, a voice, a signal on a touchscreen, a text message sent to the touchscreen, or video sent to the touchscreen from an onboard camera showing an oncoming emergency vehicle. The alert instruction 260 for instance can instruct the sound system of the vehicle to generate a voice telling the driver that an emergency vehicle 200 is approaching from a particular direction and at a particular speed. The voice character and style can be stored in memory 298, as well as the exact language used to warn the operator 299 of the emergency vehicle 200. The alert instruction 260 can also be a loud alarm in the vehicle alerting the operator 299 to an oncoming emergency vehicle 200. The alarm type can be stored in the memory 298. Furthermore, the alarm type can be altered depending on the immediacy of the emergency vehicle 200 to the vehicle. In other embodiments, the alert instruction 260 can instruct the vehicle to generate a text scrolling on a touchscreen providing the operator 299 with the information associated with the emergency vehicle 200. In still other embodiments, the alert instruction 260 causes an animation overlaid on an image or map to be shown on a vehicle's head unit. The animation can be a simple representation of the type of emergency vehicle 200. When overlaid on a map, the representation can show the location of the emergency vehicle 200, as well as the direction of travel and the speed. When overlaid on an image showing a street view, the representation can be shown as it would look on the street view. Image overlay technology is known in the art and has been disclosed in Azuma et al. (2002) IEEE 21(6):34-47, which is incorporated herein by reference.

In certain embodiments, the alert instruction 260 is a combination of instructions to cause the vehicle to generate a combination of voice alert, alarm sound, and image on the touchscreen. In particular embodiments, the alert instruction 260 instructs the operator 299 to pullover, slow down, or stop. The processor 230 executes instructions that dictate the exact command to provide. For instance, if the alert message 220 provides details explaining that the emergency vehicle 200 is behind the motor vehicle, the processor 230 will execute instructions alerting the operator 299 to pull over 270. In certain embodiments, the emergency vehicle 200 will be approaching an intersection. If the processor 230 determines that the distance to the intersection allows for the operator 299 to simply slow down the vehicle, then the processor 230 will execute such instructions 280. If the distance is determined to require the vehicle to stop, the processor 230 will execute instructions 290 commanding the operator 299 to stop. In some embodiments, the processor 230 executes instructions 295 causing the alerts to become more urgent as the emergency vehicle 200 approaches or the operator appears to be ignoring the request. In particular embodiments, the processor 230 executes instructions 297 which override operator 299 control. Instructions 297 allow for the vehicle to perform the functions of controlling speed of the motor vehicle, controlling direction of the motor vehicle, controlling radio volume of the motor vehicle, controlling onboard camera functionality of the motor vehicle, and other vehicle operations. In very particular embodiments, instructions 297 are instigated when processor 230 accesses stored information 296 where information 296 provides rules for activating instructions 297. For instance, if an operator appears to be ignoring or unable to operate the motor vehicle in a manner consistent with the commands, the processor 230 accesses information 296 to determine whether to access instructions 297 to take over operation of the motor vehicle. The information 296 can have rules relating to distance from an intersection with an approaching emergency vehicle, distance between motor vehicle and emergency vehicle, speed of the motor vehicle in relation to the distance to the emergency vehicle, and the like.

Aspects of the disclosed systems further allow for information received from GPS systems to be accessed by the processor 230. In particular embodiments, the alert signal 220 contains information relating to the position of the emergency vehicle. This information can be updated continuously so long as the motor vehicle is receiving the alert signal 220. The processor 230 further can execute instructions to access information relating to the position of the motor vehicle. Once the position of the motor vehicle is determined by GPS, the processor 230 can calculate the distance between the motor vehicle and the emergency vehicle. This information can be used to determine the proper course of action when instructing the operator.

In other embodiments, the processor 230 accesses information relating to the road conditions of the motor vehicle. In particular embodiments, the road condition information relates to weather conditions, construction conditions, time of day, temperature, width of the road, traffic speeds, traffic congestion, and other information. The processor 230 can use this information to calculate the proper command to provide to the operator. For instance, the processor 230 can access information relating to the wetness of the road from weather reports obtained over a network and obtain information from sensors in the vehicle reporting the traction on the road. The processor 230 can then calculate whether an instruction for an immediate stop command is feasible or executing instructions to slow down is safer for the operator and emergency vehicle, as well as other vehicles on the road. It should be noted that information relating to road conditions can be obtained from a variety of sources including onboard sensors, the internet, maps stored on memory, and other information stored in memory.

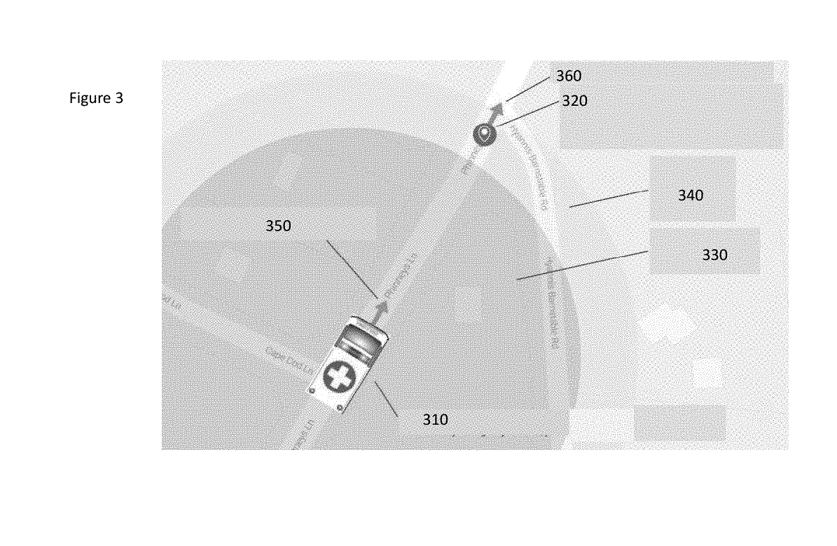

Aspects of the disclosed systems include receiving communications from emergency vehicles detailing the distance between the emergency vehicle and the motor vehicle receiving the alert message. In FIG. 3, an emergency vehicle 310 is approaching a motor vehicle 320 traveling on the same road as the emergency vehicle. The emergency vehicle 310 is sending an alert signal 340 alerting the vehicle 320 that the emergency vehicle 310 is approaching but is some distance from the vehicle. The alert signal 340 is a warning signal sent on a WLAN to transceiver on the motor vehicle 320 that is moving in direction 360. As the emergency vehicle 310 approaches in direction 350, the motor vehicle 320 will receive a signal 330 over a WPAN on its transceiver alerting the motor vehicle 320 that the vehicle 320 must be pulled over immediately. The processor executes instructions that prioritize the WPAN signal 330 over the WLAN signal 340. In such an embodiment, the processor executes instructions to alert the operator that the motor vehicle must be pulled over immediately.

In other embodiments, the alert signals 330 and 340 in FIG. 3 are sent over the same network to a transceiver on the motor vehicle. In such embodiments, the signals 330 and 340 provide a distance between the emergency vehicle 310 and the motor vehicle 320. The processor executes instructions that provide a warning to the operator that the vehicle 320 should be pulled over. If the processor calculates that the emergency vehicle 310 and the motor vehicle 320 are within a certain pre-defined distance, the processor executes instructions sending alert to the operator to pull over immediately. In some embodiments, the alerts 330 and 340 continue to become more urgent as the emergency vehicle 310 approaches the motor vehicle 320.

Aspects of the disclosed systems allow for the alert signal received from the emergency vehicle to be received over a cellular network. In some embodiments, the alert signal is received by a cellular phone within the vehicle.

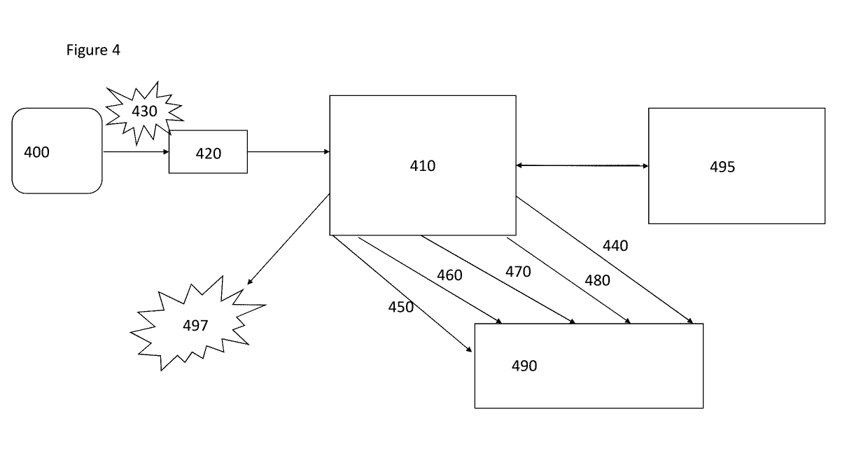

Aspects of the disclosed systems allow for controlling a motor vehicle in response to information received from an emergency vehicle. The disclosed systems comprise a processor operably linked to a memory storing executable instructions. The processor executes instructions such that an automated/autonomous motor vehicle is operated within pre-defined parameters upon receiving a signal from an emergency vehicle. As in FIG. 4, the processor 410 receives information from a transceiver 420 that the transceiver 420 received a wireless communication (e.g., alert signal) 430 from an emergency vehicle 400. The wireless communication 430 can be from a wireless PAN, wireless LAN, wireless MAN, wireless WAN, and global area networks. In some embodiments, the transceivers 420 use the Zigbee IEEE 802.15.4-based specification for short-range PAN communications and wireless protocols using the IEEE 802.11 WLAN and WMAN the IEEE 802.16 standards.

Upon receipt of the information, the processor 410 sends an override command 440 to the operations system 490 of the motor vehicle. In some embodiments, the operation system 490, which includes robotic systems and the Google self-driving system, of the motor vehicle controls the speed, direction, braking, and other systems of the vehicle. Automated motor vehicles are known in the art, including the Lexus RX450h retrofitted with the Google self-driving system.

In some embodiments, the processor 410 sends an override command 440 instructing the operating system 490 of the motor vehicle to override prior instructions in favor of an emergency protocol stored in memory 495. In particular embodiments, the processor 410 executes instructions stored in memory 495 requiring the vehicle operating system 490 to perform an operation of reducing speed of the motor vehicle 460, pulling to one side of the road of the motor vehicle 470, and/or stopping the motor vehicle 480. In some embodiments, the processor 410 also sends an alert 497 to the operating of the motor vehicle indicating the reason that the automated vehicle is taking action. When the wireless communication 430 from the emergency vehicle 400 indicates that it is safe to resume normal operation of the vehicle, the processor 410 executes instructions stored in memory 495 to send a normal operation command 450 to the operating system 490 to allow the motor vehicle to return to a normal operational state. It should be noted that the return to normal operation signal can be sent when the motor vehicle either receives no information from the emergency vehicle or the emergency vehicle sends a signal that normal operation of the motor vehicle should resume.

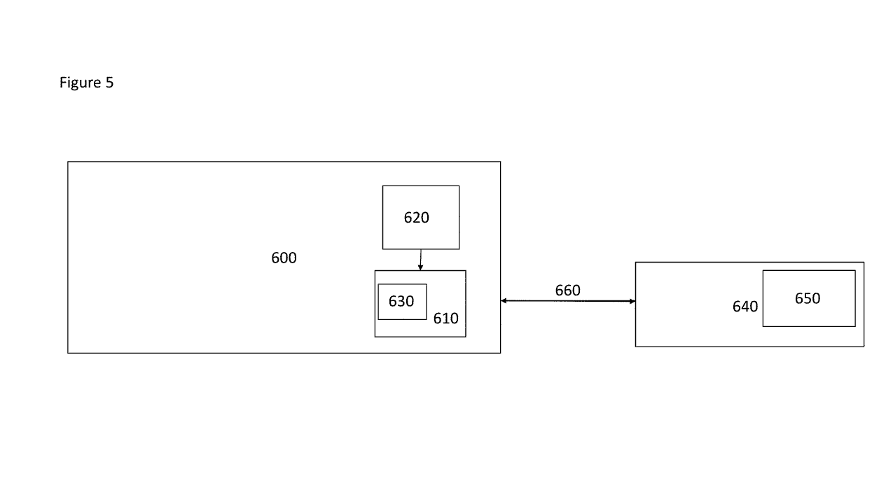

Aspects of the methods and systems disclosed herein further allow for an emergency vehicle or other vehicle to communicate by way of Wi-Fi or radio signal (such as FM signals) (FIG. 5). The emergency vehicles and other vehicles 600 disclosed herein comprise one or more computer-readable memories 610—which can be transitory or non-transitory memories—accessible by a processor 620. The computer-readable memories 610 have instructions 630 allowing execution by the processor 620. The emergency vehicle or vehicles 600 can access one or more servers 640 over an internet connection 660 having data stored in a database 650 stored on the one or more servers 640. Such data can be downloaded from the one or more servers 640 and stored in the computer-readable memories 610 where it can be later accessed by the operator of the emergency vehicle or the operators of the other vehicles 600. The data can comprise information relating to road conditions, weather, vehicle type, or any other information accessible in a database. The emergency vehicle and other vehicles 600 can further upload information to the one or more servers 640 over the internet connection 660. In certain embodiments, the uploaded information relates to the status of the emergency vehicle and other vehicles 600 such as tire pressure, speed, engine performance, and other factors recorded by onboard systems.

### EOUIVALENTS

Those skilled in the art will recognize, or be able to ascertain, using no more than routine experimentation, numerous equivalents to the specific embodiments described specifically in this disclosure. Such equivalents are intended to be encompassed in the scope of the following claims.

1. A method of alerting an operator of a motor vehicle to the presence of an emergency vehicle in the operator's vicinity, the method comprising:
(a) receiving information from the emergency vehicle by wireless communication to the motor vehicle;
(b) in response to the received information, overriding one or more systems in the motor vehicle, the one or more systems comprising radio volume control, phone volume control, screen functionality, onboard camera functionality, or combinations thereof, and
(c) alerting the operator of the motor vehicle to the presence of the emergency vehicle.

2. The method of claim 1 further comprising confirming the accuracy of the information from the emergency vehicle by reviewing database of codes relating to the emergency vehicle.

3. The method of claim 1 further comprising alerting the operator of the motor vehicle to the speed of the emergency vehicle, the direction of travel of the emergency vehicle, and the type of emergency vehicle.

4. The method of claim 1, wherein information comprises the speed of the emergency vehicle, the direction of travel of the emergency vehicle, and the type of emergency vehicle.

5. The method of claim 1, wherein the screen functionality comprises touchscreens configured to show maps and video images.

6. The method of claim 1, wherein the motor vehicle overrides the screen functionality to show an image of the emergency vehicle.

7. The method of claim 6, wherein the image of the emergency vehicle is an animation of the emergency vehicle.

8. The method of claim 7, wherein the animation is overlaid on a map showing the location of the emergency vehicle relative to the motor vehicle.

9. The method of claim 1 further comprising instructing the motor vehicle's radio volume control or phone volume control to reduce a volume to a pre-determined level in response to receiving information from the emergency vehicle.

10. The method of claim 1 further comprising instructing one or more cameras positioned on the motor vehicle to an active state.

11. The method of claim 10 further comprising instructing a screen positioned in the motor vehicle to display images from the one or more cameras to the operator.

12. The method of claim 1 further comprising generating an alert signal such that the operator is aware of the presence of the emergency vehicle.

13. The method of claim 12, wherein the alert signal is a repeating sound or a voice describing the type of vehicle, direction of the vehicle, and speed of the vehicle.

14. The method of claim 12, wherein the alert signal is a voice instructing the operator to pull over, slow down to a particular speed, or stop.

15. The method of claim 1 further comprising providing text on a screen mounted within the motor vehicle to alert the operator to the presence of the emergency vehicle.

16. The method of claim 1 further comprising instructions to provide the motor vehicle operator information regarding the type of emergency vehicle.

17. The method of claim 1 further comprising identifying a safe position on a road to pull over, stop, or slow down.

18. The method of claim 1 further comprising providing information to the motor vehicle operator regarding a safe position on a road to pull over, stop, or slow down.

19. The method of claim 1 further comprising receiving information relating to the status of the emergency vehicle.

20. The method of claim 19 further comprising informing the motor vehicle operator whether it was proper to continue or remain pulled over, stopped, or slowed down.

21.-74. (canceled)
